(19) United States
(12) Patent Application Publication
(10) Pub. No.: US 2007/0269545 A1
(43) Pub. Date: Nov. 22, 2007

(54) Magnetic quick change mold

(75) Inventors: Earle Ellis, York, PA (US); Roy N. Krohn, Wrightsville, PA (US); David A. Kesselman, York, PA (US)

Correspondence Address: SYNNESTVEDT & LECHNER, LLP, 1101 MARKET STREET, 26TH FLOOR, PHILADELPHIA, PA, 19107-2950, US

(73) Assignee: Graham Packaging Company, L.P., York, PA (US)

(21) Appl. No.: 11/434,129

(22) Filed: May 16, 2006

(51) Int. Cl. B29C 49/48

(52) U.S. Cl. 425/3; 425/195; 425/540

(57) ABSTRACT

A mold mounting system is provided for use with a wheel-type blow mold machine. The system has a first platen; a first mold half having at least one mold cavity for forming a container; a first magnet mounted on the first platen or the first mold half, the first magnet being for releasably magnetically attaching the first mold half to the first platen; a second platen; a second mold half having at least one mold cavity for forming the container; and a second magnet mounted on the second platen or the second mold half, the second magnet being for releasably magnetically attaching the second mold half to the second platen. The first and second mold halves are adapted to interface with each other during a molding process.

### BACKGROUND OF THE INVENTION

The present invention relates generally to molds, and more particularly to molds for molding plastic bottles.

Wheel-type blow mold machines are used for blow molding bottles and other plastic containers. These blow mold machines typically have a number of removable molds (for example, 12 or 24). The removable molds are specific to a particular bottle or container and must be changed to produce a different bottle or container. The operation of changing the molds of a conventional wheel-type blow mold machine can be labor intensive and require a long shut down period. Typically, each mold includes a number of connections and devices that require disconnecting and reconnecting each time the molds are changed. In addition, conventional molds can be very heavy and large, requiring additional manpower and or machinery to move and position.

### BRIEF SUMMARY OF THE INVENTION

Particular embodiments of the invention provide a mold mounting system for use with a wheel-type blow mold machine. The system has a first platen; a first mold half having at least one mold cavity for forming a container; a first magnet mounted on the first platen or the first mold half, the first magnet being for releasably magnetically attaching the first mold half to the first platen; a second platen; a second mold half having at least one mold cavity for forming the container; and a second magnet mounted on the second platen or the second mold half, the second magnet being for releasably magnetically attaching the second mold half to the second platen. The first and second mold halves are adapted to interface with each other during a molding process.

Other embodiments of the invention provide a mold set for use with a wheel-type blow mold machine having a first platen and a second platen. The mold set has a first mold half having at least one mold cavity for forming a container, a first magnet mounting recess, and a first magnet mounted in the first magnet mounting recess, the first magnet being for releasably magnetically attaching the first mold half to the first platen. The mold set also has a second mold half having at least one mold cavity for forming the container, a second magnet mounting recess, and a second magnet mounted in the second magnet mounting recess, the second magnet being for releasably magnetically attaching the second mold half to the second platen. The first and second mold halves are adapted to interface with each other during the molding process.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of preferred embodiments of the invention, as illustrated in the accompanying drawings wherein like reference numbers generally indicate identical, functionally similar, and/or structurally similar elements.

FIG. 1 is a schematic side view of a mold mounting system in accordance with the invention mounted on platens of a wheel-type blow mold machine;

FIG. 2 is a front view of the mold mounting system shown in FIG. 1; and

FIG. 3 is a cross-sectional view along section line III-III shown in FIG. 2.

### DETAILED DESCRIPTION OF PREFERRED EMBODIMENTS

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention.

Embodiments of the invention improve upon the conventional molds for use with, for example, a wheel-type blow mold machine by permitting the molds to be easily removed from the platens.

The invention provides a system that greatly reduces the time required to remove a mold set from a wheel-type blow mold machine and replace it with another mold set. Replacing molds with a conventional system is a time consuming effort that requires the removal of four to eight water hoses from the mold, the removal of one or two blow cylinders from the mold, the exchange of blow needles appropriate for the new mold and the removal of four screws per mold half to remove mold half from the platen. This procedure is then reversed to install the new molds. For a wheel-type blow mold machine having 24 molds, the above procedure is repeated for each of the 24 molds.

A mold mounting system in accordance with the invention holds the mold halves onto their respective platens by means of a permanent magnet. In one embodiment of the invention, the magnet is bolted to the aluminum mold half, the mold half is aligned to the platen by way of a key that is adjustable for the “tilt” setup for each mold set. A safety pin is used to assure that the mold halves stay mounted to their respective platens in case of an accidental deactivation of one or both of the magnets. In particular embodiments, the blow cylinders and ejector assemblies stay mounted to the mold halves when the mold halves are disconnected from their respective platens. Multiple alignment methods for aligning the mold halves relative to their respective platens and each other can be used. For example, a key can be used to align each mold half relative to its respective platen, pins and bushings can be used to align the mold halves (more specifically the mold cavities) relative to each other, and pins and bushings can be used to align each mold half relative to a water manifold of the blow mold machine.

Molds for wheel-type blow mold machines are typically made of aluminum which, as is well known, is not influenced by magnetic force fields. As a result, either a magnet or a plate of material that is influenced by magnetic forces is mounted on, or in a recess in, each of the aluminum mold halves. The magnet, whether mounted on the platen or on the mold half, is provided with a means for turning the magnet on and off. In particular embodiments, the plate (or the magnet) that is mounted on the platen is pivotable around a dowel pin so as to maintain the ability to change the mold position in the blow molder as needed depending on the process. The plate can also function as a key to facilitate the correct placement of the mold on the platen prior to turning on the magnets. As the mold is being slid into location on the key, the water connection can be made and alignment pins can engage between the mold and the water manifold to ensure proper alignment. Once the mold is in proper position, a safety pin can be inserted to ensure that the mold half does not separate from the platen even if the magnet fails. Connection of air lines to the blow cylinders by way of quick change fittings completes the mold reinstallation process.

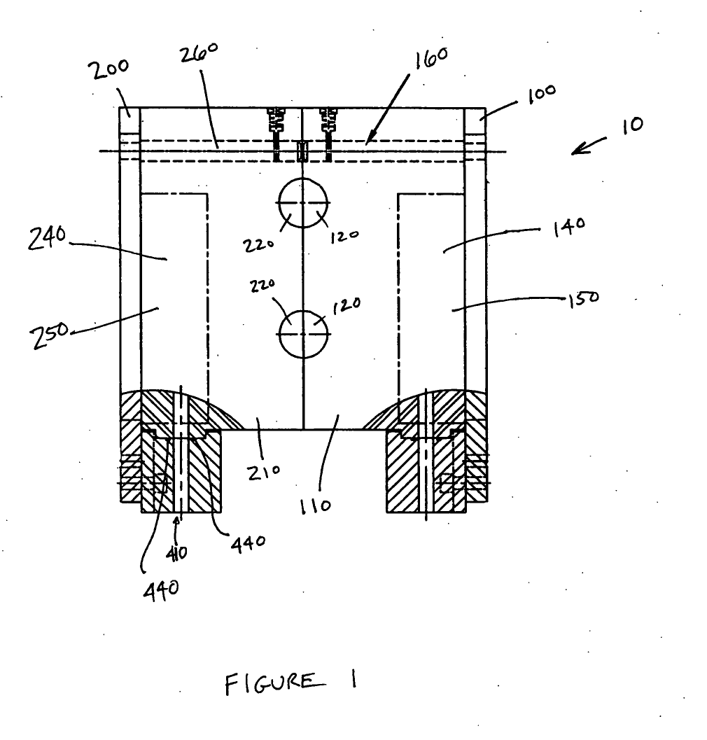

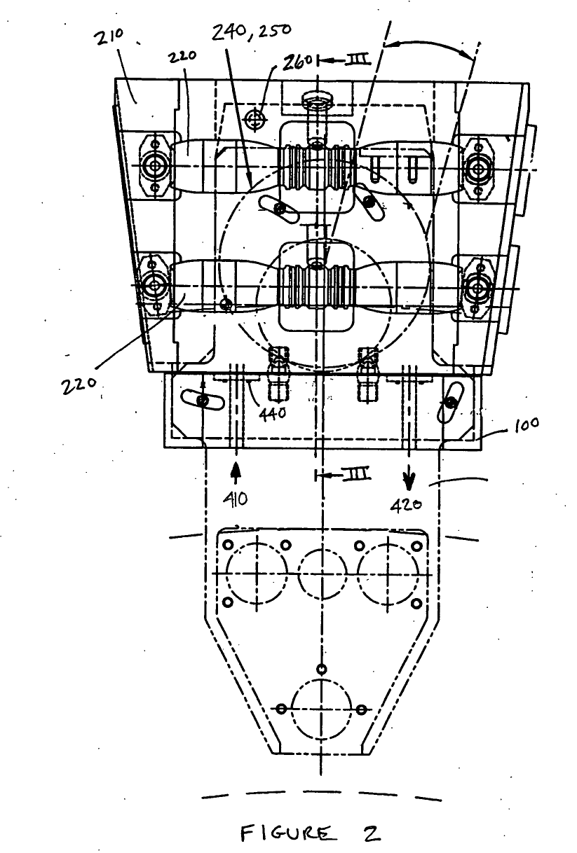

An example of an embodiment of the invention is shown in FIGS. 1-3. FIG. 1 shows mold halves 110, 210 attached to platens 100, 200 respectively. FIG. 2 is rotated 90 degrees relative to FIG. 1 and shows a face of mold half 210. As can be seen from FIG. 2, mold half 210 has two mold cavities 220 for forming plastic containers. In the example shown in FIG. 2, four bottles (two in each mold cavity 220) will be formed by each cycle of the mold.

As seen in FIG. 1, mold half 110 has a magnet mounting recess 140 in which a magnet 150 is mounted. Similarly, mold half 210 has a magnet mounting recess 240 in which a magnet 250 is mounted. Magnets 150, 250 can be secured to mold halves 110, 210 respectively, by bolts or other fixing devices. Platens 100, 200 can be made of steel or other material that is subject to magnetic forces, or a plate that is subject to magnetic forces can be recessed in, or mounted to, platens 100, 200. Although magnets 150, 250 are shown in this example as being attached to mold halves 110, 210, it is noted that in other embodiments the magnets can be attached to the platens and plates subject to magnetic forces can be attached to the mold halves.

FIG. 1 also shows safety pins 160, 260 that secure mold halves 110, 210 to platens 100, 200, respectively, to ensure that mold halves 110, 210 cannot separate from platens 100, 200, respectively, even if magnets 150, 250 fail.

FIG. 2 further shows a water inlet 410 and a water outlet 420 for circulating cooling water within mold half 210. Seal 440 creates a watertight seal between mold half 210 and a member in which water inlet 410 is formed. As mold half 210 is slid into position on platen 210, the watertight seal is made.

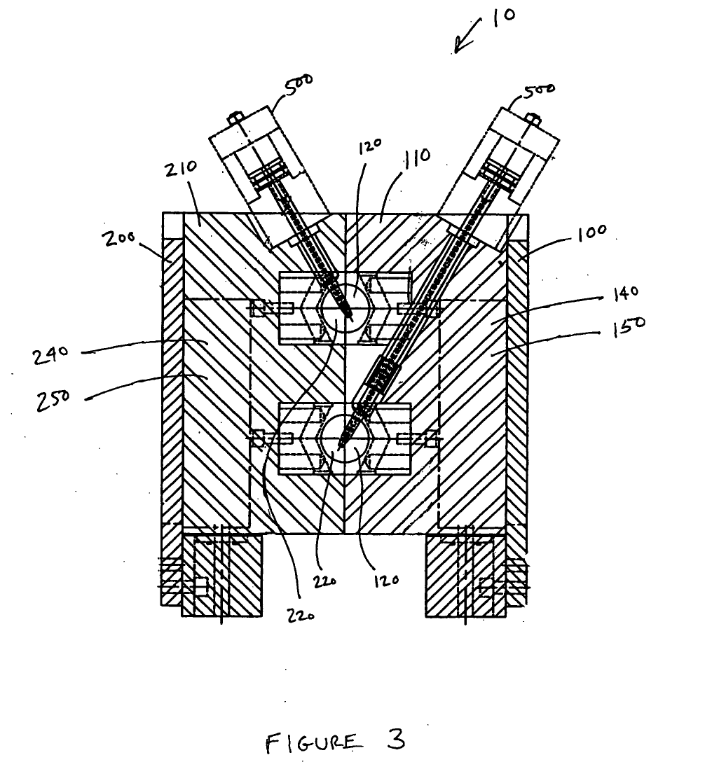

FIG. 3 is a sectional view of mold mounting system 10 along section line III-III in FIG. 2. In addition to features discussed previously, FIG. 3 also shows two blow pin assemblies 500 that are mounted in mold halves 110, 210 and can remain mounted in the mold halves when the mold halves are removed from the platens.

It is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention.

The embodiments illustrated and discussed in this specification are intended only to teach those skilled in the art the best way known to the inventors to make and use the invention. Nothing in this specification should be considered as limiting the scope of the invention. All examples presented are representative and non-limiting. The above-described embodiments of the invention may be modified or varied, without departing from the invention, as appreciated by those skilled in the art in light of the above teachings. It is therefore to be understood that the invention may be practiced otherwise than as specifically described.

What is claimed is:

1. A mold mounting system for use with a wheel-type blow mold machine, the system comprising:
a first platen;
a first mold half having at least one mold cavity for forming a container;
a first magnet mounted on the first platen or the first mold half, the first magnet being for releasably magnetically attaching the first mold half to the first platen;
a second platen;
a second mold half having at least one mold cavity for forming the container; and
a second magnet mounted on the second platen or the second mold half, the second magnet being for releasably magnetically attaching the second mold half to the second platen,
wherein the first and second mold halves are adapted to interface with each other during a molding process.

2. The mold mounting system of claim 1, further comprising a first magnet mounting recess in the first mold half, and a second magnet mounting recess in the second mold half,
wherein the first magnet is mounted in the first magnet mounting recess, and the second magnet is mounted in the second magnet mounting recess.

3. The mold mounting system of claim 2, wherein the first magnet is fixed in the first magnet mounting recess such that the first magnet cannot move relative to the first mold half, and
the second magnet is fixed in the second magnet mounting recess such that the second magnet cannot move relative to the second mold half.

4. The mold mounting system of claim 1, wherein the first magnet is bolted to the first mold half, and
the second magnet is bolted to the second mold half.

5. The mold mounting system of claim 1, wherein the first magnet is a permanent magnet, and
the second magnet is a permanent magnet.

6. The mold mounting system of claim 1, further comprising a first key, the first mold half being aligned to the first platen by way of the first key, and
a second key, the second mold half being aligned to the second platen by way of the second key.

7. The mold mounting system of claim 6, wherein the first key is adjustable to adjust the tilt of the first mold half relative to the first platen.

8. The mold mounting system of claim 7, wherein the second key is adjustable to adjust the tilt of the second mold half relative to the second platen.

9. The mold mounting system of claim 1, further comprising a first safety pin for securing the first mold half to the first platen and keeping the first mold half attached to the first platen if the first magnet is deactivated, and
a second safety pin for securing the second mold half to the second platen and keeping the second mold half attached to the second platen if the second magnet is deactivated.

10. The mold mounting system of claim 1, further comprising
a first blow cylinder attached to the first mold half and configured to remain attached to the first mold half when the first mold half is detached from the first platen, and
a second blow cylinder attached to the second mold half and configured to remain attached to the second mold half when the second mold half is detached from the second platen.

11. The mold mounting system of claim 10, further comprising quick-disconnect fittings for disconnecting fluid lines attached to the blow cylinders from the respective platens.

12. The mold mounting system of claim 1, further comprising
a first ejector assembly attached to the first mold half and configured to remain attached to the first mold half when the first mold half is detached from the first platen, and
a second ejector assembly attached to the second mold half and configured to remain attached to the second mold half when the second mold half is detached from the second platen.

13. The mold mounting system of claim 1, further comprising a plurality of pins and bushings for aligning the mold cavity of the first mold half to the mold cavity of the second mold half.

14. The mold mounting system of claim 13, further comprising an alignment mechanism for aligning each mold half to a respective water manifold.

15. The mold mounting system of claim 14, wherein the alignment mechanism is a plurality of pins and bushing for aligning each mold half to its respective water manifold.

16. The mold mounting system of claim 1, further comprising a magnet control device for selectively switching the magnetism of the magnets between an on condition to an off condition.

17. The mold mounting system of claim 1, further comprising
a first key, the first mold half being aligned to the first platen by way of the first key, and a second key, the second mold half being aligned to the second platen by way of the second key, the first key being adjustable to adjust the tilt of the first mold half relative to the first platen, and the second key being adjustable to adjust the tilt of the second mold half relative to the second platen;
a first safety pin for securing the first mold half to the first platen and keeping the first mold half attached to the first platen if the first magnet is deactivated, and a second safety pin for securing the second mold half to the second platen and keeping the second mold half attached to the second platen if the second magnet is deactivated;
a plurality of pins and bushings for aligning the mold cavity of the first mold half to the mold cavity of the second mold half;
a plurality of pins and bushing for aligning each mold half to a respective water manifold; and
a magnet control device for selectively switching the magnetism of the magnets between an on condition to an off condition.

18. A mold set for use with a wheel-type blow mold machine having a first platen and a second platen, the mold set comprising:
a first mold half having
at least one mold cavity for forming a container;
a first magnet mounting recess; and
a first magnet mounted in the first magnet mounting recess, the first magnet being for releasably magnetically attaching the first mold half to the first platen; and
a second mold half having,
at least one mold cavity for forming the container;
a second magnet mounting recess; and
a second magnet mounted in the second magnet mounting recess, the second magnet being for releasably magnetically attaching the second mold half to the second platen,
wherein the first and second mold halves are adapted to interface with each other during the molding process.

19. The mold set of claim 18, wherein the first magnet is fixed in the first magnet mounting recess such that the first magnet cannot move relative to the first mold half, and
the second magnet is fixed in the second magnet mounting recess such that the second magnet cannot move relative to the second mold half.

20. The mold set of claim 18, further comprising a first key for aligning the first mold half to the first platen, and
a second key for aligning the second mold half to the second platen.

21. The mold set of claim 20, wherein the first key is adjustable for adjusting the tilt of the first mold half relative to the first platen.

22. The mold set of claim 21, wherein the second key is adjustable for adjusting the tilt of the second mold half relative to the second platen.

23. The mold set of claim 18, further comprising a first safety pin for securing the first mold half to the first platen and keeping the first mold half attached to the first platen if the first magnet is deactivated, and
a second safety pin for securing the second mold half to the second platen and keeping the second mold half attached to the second platen if the second magnet is deactivated.

24. The mold set of claim 18, further comprising
a first blow cylinder attached to the first mold half and configured to remain attached to the first mold half when the first mold half is detached from the first platen, and
a second blow cylinder attached to the second mold half and configured to remain attached to the second mold half when the second mold half is detached from the second platen.

25. The mold set of claim 24, further comprising quick-disconnect fittings for disconnecting fluid lines attached to the blow cylinders from the respective platens.

26. The mold set of claim 18, further comprising
a first ejector assembly attached to the first mold half and configured to remain attached to the first mold half when the first mold half is detached from the first platen, and
a second ejector assembly attached to the second mold half and configured to remain attached to the second mold half when the second mold half is detached from the second platen.

27. The mold set of claim 18, further comprising a plurality of pins and bushings for aligning the mold cavity of the first mold half to the mold cavity of the second mold half.

28. The mold set of claim 27, further comprising an alignment mechanism for aligning each mold half to a respective water manifold.

29. The mold set of claim 18, further comprising a magnet control device for selectively switching the magnetism of the magnets between an on condition to an off condition.

30. The mold set of claim 18, further comprising
a plurality of pins and bushings for aligning the mold cavity of the first mold half to the mold cavity of the second mold half; and
a plurality of pins and bushing for aligning each mold half to a respective water manifold,
wherein the first magnet is fixed in the first magnet mounting recess such that the first magnet cannot move relative to the first mold half, and
the second magnet is fixed in the second magnet mounting recess such that the second magnet cannot move relative to the second mold half.
